(19) United States
(12) Patent Application Publication
(10) Pub. No.: US 2018/0023341 A1
(43) Pub. Date: Jan. 25, 2018

(54) CUSHION FOR PROFILE OF A SHADE FOR DOORS OR WINDOWS

(71) Applicant: PLASTEX SA, Madonna del Piano (CH)

(72) Inventor: Marco Lombardini, Vernate (CH)

(21) Appl. No.: 15/668,564

(22) Filed: Aug. 3, 2017

Related U.S. Application Data
(63) Continuation-in-part of application No. 15/507,908.

(51) Int. Cl. E06B 9/58; E06B 9/38

(52) U.S. Cl. CPC E06B 9/582; E06B 9/38; E06B 9/58; E06B 2009/588

(57) ABSTRACT

A cushion for a profile of a shade of a door or window, includes at least one flexible tongue which acts as a cushion between the profile and a frame for assembly of the profile. A base portion of the flexible tongue is adapted to be directly faced towards the profile, in use, and at least an end portion of the flexible tongue is adapted to be directly faced towards the frame.

### FIELD OF APPLICATION

Embodiments of the present invention relate to a cushion for a profile of a shade for a door or window.

Embodiments of the present invention also relate to a profile of a shade for a door or window.

Embodiments of the invention also relate to a method of mounting the cushion on the profile of the shade of the door or window.

### BACKGROUND

It is known that a shade of a door or window, for example a blind for a window, can be retracted from the door or window to allow the light to pass through, or extended along it, for darkening. The sliding action is for example of the sliding-shutter type, in which case the shade slides along a pair of uprights associated with a frame of the door or window or incorporated therein.

The uprights are generally perpendicular to the floor and the shade slides vertically. In some cases the uprights are instead horizontal and the shade slides horizontally. More particularly opposite sides of the shade are inserted in profiles, preferably plastic, which form the guide of the shade in the upright. The profile has substantially the same length as the upright and is restrained in a thickness of the upright with predefined play, which facilitates the horizontal movement of the shade (in the case of a horizontally sliding shade) or vertical (in the case of vertically sliding shade). In some cases the uprights are neither parallel nor perpendicular to the floor but have a predefined angle with respect thereto, for example an acute angle. This is the case, for example, of a door or window mounted on an opening in a sloping roof, such as a skylight, or of other awnings, optionally installed outside, on balconies or on terraces. The profile in these shades, since it is in the upright, is also inclined with respect to the floor and the shade is sliding with the same inclination. These shades are therefore also known as “oblique sliding shades”. FIGS. 1 and 1a show a detail of a profile A (FIG. 1) according to the prior art and a front-end section thereof (FIG. 1a). The profile A, as already mentioned, is inserted in the upright of the frame of a door or window and comprises a seat S for an edge or side of the shade, for example of a blind. During assembly the edge of the shade is slidingly insertable in the seat S through an opening I of the profile, leaving the rest of the shade to project from the seat S (and from the upright) through a slit B of the profile, with breadth smaller than the edge of the shade, in order to restrain the edge in the seat S. The opposite edge of the shade is similarly associated with a profile of the other upright of the frame.

A sponge element C is glued along the profile. When the sponge element C is expanded, i.e. at rest, it constitutes a predetermined encumbrance and ensures spacing between the upright and the profile and keeps the shade tensioned. When instead it is compressed it acts as a cushion between the profile and the upright. This occurs in particular during the opening or closing manoeuvres, which tend to move the shade between the uprights, or under the effect of the wind.

However the sponge elements indicated above are subject to considerable limitations. First of all they are subject to alterations which affect the elasticity thereof, be it irreversibly, for example owing to wear or drying, or reversibly, for example due to changes in climate, temperature, humidity or season, which temporarily influence the elasticity, in any case preventing the sponge element from expanding sufficiently in order to fill the space between upright and profile and from guaranteeing therefore a correct pretensioning and also adequate cushioning, due to the altered elasticity of the material. Moreover the spongy material from which the sponge element is made becomes worn over time, as a consequence of repeated rubbing against the walls of the upright. The sponge element is glued to the profile but projects therefrom, also during compression, and is not very stable.

Furthermore, the wear can cause detachment of the sponge element from the profile and further loss of efficiency both when damping the impact against the upright and during pretensioning. Moreover, mounting thereof is somewhat laborious, especially if performed manually. Furthermore, especially in oblique sliding shades, the force of gravity tends to deform the shade, generating a downward bowing effect which cannot be in any way avoided by the known sponge elements.

Finally, but not least in order of importance, there is the limited cushioning capacity of the sponge element which, being arranged between the profile and the upright, constitutes even during maximum compression thereof a thickness which prevents the shade and the profile from moving further towards the upright. More particularly, during maximum compression, the sponge element loses its cushioning capacity and acts as a substantially rigid body, arranged between upright and profile, without reducing the noise and without increasing the stability of the shade. This occurs especially where there is wind, in particular, but also during the manoeuvres for opening and closing the shade.

Given all that stated above, the known shades are also somewhat noisy, especially when extended along the door or window, due to the fact that they may be struck by air currents and moved suddenly between the uprights, making the profiles hit against them. In fact, when the air acts on the surface of the shade, the shade moves the profile which, as mentioned, is coupled to the upright with predetermined play, causing it to hit against the latter.

It is known that some profiles have an integrated cushion, which substantially takes the form of two flexible walls of the profile, extending (for example perpendicularly) from one of the bases thereof and having an edge which touches the upright. The walls extend along the entire profile and are made as one piece with it.

Even if these cushioning walls solve some technical problems associated with the sponge elements mentioned above (in fact they are not generally prone to detachment from the base), they are not however effective for guaranteeing optimal pretensioning of the shade and not even for improving the cushioning action.

In fact the walls always constitute an encumbrance between profile and upright, also during maximum compression, and therefore they limit the movement of the shade in either direction, towards the uprights. This limitation is also associated with the extension of the walls along the entire profile, and therefore along the entire upright. Finally, these side walls do not solve in any way the problems of bowing associated with oblique sliding shades and they are not therefore suitable for creating effective pretensioning.

Finally cushions made of another material are known, in particular plastic materials, suitable for being mounted on a section of the edge of the profile and for performing their cushioning function between the section of the edge on which they are mounted and the section of upright facing it. However these cushions are also affected by the same problem mentioned above for known sponge elements, namely they constitute a substantially rigid body, especially during maximum compression, situated between the upright and the profile section on which they are mounted, without being able to improve the pretensioning or the cushioning action or being able to increase the stability of the shade.

The technical problem forming the basis of the present invention is that of devising a cushion for a shade of a door or window, for example for the blind of a light-screening system, which is very simple to produce and simple to mount on the profile, also mechanically, and which is able to reduce effectively the noise caused by the movement of the profile in the upright, avoiding damage to the shade due to the opening, closing or adjustment manoeuvres or to the action of the wind, while also ensuring an optimum tension of the shade, both in windy conditions and when there is no wind, and which finally is low-cost and able to overcome all the limitations and the drawbacks which still affect the known cushions.

The co-extruded profile must be criticised since it cannot react to winter and to summer conditions.

### SUMMARY

The idea forming the basis of the present invention is that of providing a cushion for a shade of a light-screening system, adapted to be associated to a profile intended to be inserted in an upright (frame) of the door or window, and configured to cushioning between the upright and the profile.

According to an aspect of the invention, the cushion is not fixed to the profile or to the upright. For instance, the cushion is floating in a space between the profile and the upright, and it is subject to elastic deformations in its shape, due to reduction of the space caused by movement of the profile towards the upright, for instance in presence of wind, when the cushion is sandwiched between profile and frame.

The cushion may have a U shape having a predetermined curvature at rest, end portions of the cushion are arranged towards a surface of the upright (or a surface of the profile), and a base portion of the cushion, between the end portions, is arranged towards a surface of the profile (or upright, respectively). The base portion is preferably the portion at the middle of the end portions of the U-shaped cushion.

In absence of compression, the end portions and the middle portion may contact the respective surface. Preferably, only one among the end portions and the middle portion contact a surface of the profile or upright in absence of compression.

Although, a U shape is referred below, the cushion may have different shapes.

When the profile is moved towards the upright, for instance due to the wind, its predetermined curvature is changed, due to elastic deformation.

In one embodiment of the invention, at a maximum compression, the U-shape cushion is flattened; the thickness of the cushion prevents the profile from contacting the upright also at the maximum compression.

In another embodiment, at the maximum compression, the cushion has a minimum curvature and it is not flattened. The minimum curvature depends on the material used to manufacture the cushion, i.e. its flexibility.

According to an aspect of the invention, only one cushion is arranged between the upright and the profile, preferably a cushion having a length substantially corresponding to a length of the profile or to a length of the upright.

According to another aspect of the invention, a plurality of cushions are arranged between the upright and the profile. For instance each cushion has a length between 2 and 10 cm.

The cushions may be arranged at a predetermined distance or pitch, one from the other; for instance a distance from one cushion to the other is between 20 to 80 cm.

In this case, means to couple the cushion to the profile or to the upright, preferably to the profile, are provided. The coupling means prevents one cushion from contacting another cushion or from making interference with another cushion due to overlapping in a same portion of the profile. The coupling means attach one cushion at a portion of the profile. Preferably, the coupling means are releasable and the cushion is removable from the profile.

For instance, the coupling means is a pin on the cushion adapted to be inserted in a locking hole of the profile. In case of a U-shaped cushion, the pin may be arranged at the middle portion of the cushion.

In another embodiment, the means for coupling, for instance the pin, is provided on one or both the end portions of the U-shaped cushion, which is or are adapted to be locked in a hole in the profile or upright.

Different coupling means may be used to associate the cushion(s) to the profile or upright.

In one embodiment, a portion of the cushion, for instance the middle portion of the U-shaped cushion, is glued on a surface of the profile. The glue is applied on an outer surface of the middle portion or on the profile.

A profile, which is also the subject matter of the present invention, may be provided with one or a plurality of cushions adapted to be coupled or already coupled to the profile, for instance glued or attached by pin and locking holes, or through other coupling means.

In one embodiment, the profile comprises two longitudinal sides or flanges and the cushions are applied to the two longitudinal sides. For instance, the cushions are arranged at a predetermined distance or pitch, one from the other, on the two sides of the profile.

At a cushion arranged at a predetermined position on a side of the profile corresponds another cushion arranged at the predetermined position on the other side of the profile, so as the two cushions are aligned on the counter posed sides.

In another aspect, the cushions are alternately arranged on the counter posed sides, i.e. at a predetermined position on a side of the profile on which a cushion is arranged correspond a predetermined position on the other side of the profile which is free from cushions. This arrangement is particularly advantageous for same applications or to reduce the number of cushions. For instance, on each meter of the profile, just three cushions may be applied or mounted, one cushion on one side and two cushions on the other side.

Advantageously, according to an aspect of the present invention, the cushion comprises a flexible tongue, preferably a U-shaped tongue and a surface of the tongue is directly faced to the profile, i.e. with no means interposed between the tongue and the profile. For instance, the tongue is attached to the profile by means of glue or a locking pin.

In case of U-shape tongue, the middle portion of the tongue which is between the end portions is directly faced to the profile; the middle portion may be fixed to the profile.

For instance, at rest, the end portions contact the upright at corresponding contact points on the upright, and are in a predetermined distance one from the other, corresponding to an aperture of the U-shaped tongue at rest.

In a compressing phase, for instance in presence of wind, the cushion is pushed against the upright by the profile which contacts the outer surface of the tongue at its middle portion, so that the distance between the end portions is increased, corresponding to an increase of the aperture of the U-shape tongue; in such operative phase, the end portions contact the upright at different contact points, more distanced from the contact points at rest. More particularly, the end portions of the tongue slides on the upright from the contact points at rest to the contact point at compression phase. When the profile returns to its position distanced from the upright, the cushion elastically returns to its shape with predetermined curvature, by sliding the end portions on the upright.

According to another aspect of the invention, the end portions and the middle portion of the tongue are arranged to contact the profile and the upright in three contact points, two of which (the points on the upright contacted by the end portions) are variable due to compression and release, and one of which (the point on the profile) is not variable.

Different materials may be used for the tongue. In one embodiment the tongue is plastic. In another embodiment the tongue is metallic. In a further embodiment, the tongue is metallic and at least a portion of the tongue, preferably the entire tongue, is covered by plastic material. In another embodiment, a portion of the tongue is plastic and another portion is metallic or in plastic covered by metal. When plastic is used, a transparent plastic is preferred. More preferably UV resistant plastic is used.

The U-shaped tongue may have a rectangular section.

The tongue may have a predetermined and constant width, for instance from 0.3 to 2 cm, preferably around 0.6 cm. A height from the middle portion of the tongue to the end portion, measured on an axis perpendicular to the centre of the middle portion may be from around 0.8 cm to around 3 cm. In an embodiment, the end portions are curved to prevent gripping the upright; the width of the tongue at the curved end portions is less than the width of the tongue in the other portions.

Advantageously, the tongue between the profile and the upright improves the cushioning, especially in some working conditions, such as under gusts of wind. Moreover, the tongue disclosed above is particularly adapted to work with profiles mounting curtains of different material or curtains having different degrees of extensions or retractions in presence, respectively, of increases or decreases of the temperature, especially when textiles or PVC fabrics are used.

Nothing prevents that a tongue having a base portion to be associated to the profile, for instance glued or inserted through a pin/hole coupling in the profile, and only one end portion to be associated to the upright is used. Such a cushion may have a predetermined curvature at rest, for instance a concavity towards the up with respect to the profile and with the only one end portion adapted to contact the upright.

As well, a tongue with no curvature may be provided, for instance a tongue including a base portion and an extension portion extending from the base with a predetermined inclination. The end portion at the end of the extension portion is adapted to contact the upright, in use, and the cushioning is obtained by decreasing (compression phase) the inclination of the extension portion with respect to the base. Preferably the extension portion is flexible and an interface between the base portion and the extension portion is flexible.

According to an embodiment of the invention, the cushion comprises a first portion able to be mounted on a first section of the profile and a second portion which acts as cushion. The secondo portion may act between the upright and a second section of the profile.

The first section and the second section of the profile may be different or partially overlapped. For example the first portion of the cushion may be mounted on a first section of the profile and the second portion is connected to one end of the first portion and is intended to operate along a second section of the profile which is completely free from the first portion.

The second portion of the cushion may comprise a first part which performs its cushioning function already at one end of the first section of the profile and a second part which performs its cushioning function along the second section of the profile.

One end of the second portion is preferably coplanar with a surface of the first portion.

Advantageously, according to the proposed solution disclosed above, during maximum compression, the second portion of the cushion does not constitute any encumbrance between the profile and the upright.

According to the proposed solution disclosed above, the first portion is a channel which can be mounted on the first profile section and the second portion is a tongue with one end on the channel, which extends outside the channel, at least in the longitudinal direction of the channel. In particular, the flexible tongue is on one face of the channel and extends in the direction L along which the profile extends, beyond the side opening of the channel. More particularly the channel has a front opening FR and two opposite lateral openings LAT and said at least one flexible tongue extends beyond the lateral openings or opening of the channel.

According to a preferred embodiment of the present invention, the technical problem disclosed above is solved by a cushion for a profile of a shade for a door or window, comprising a channel which can be mounted on the profile, having a substantially C-shaped cross section, and at least one flexible tongue on the channel, which acts as cushion between the profile and a frame (or upright) for assembly of the profile, and characterized in that said at least one flexible tongue extends in the longitudinal direction L of the channel, projecting outside thereof from at least one side. More particularly the flexible tongue extends beyond the lateral openings or opening of the channel.

Advantageously, projecting outside of the channel, the tongue acts as cushion on a section of the profile on which the channel is not mounted and allows the profile to come very close to the upright.

Preferably the flexible tongue has a proximal portion fixed on the channel and a remaining portion projecting from the channel also in a vertical direction V, so as to be spaced from the channel.

More particularly, at rest, i.e. when there is no action, for example of the air, on the shade, a distal end of the flexible tongue is spaced both in longitudinal direction (L) and in transverse direction (direction V) from the channel Preferably, when the parts are assembled and in said rest position, the end of the flexible tongue touches the upright. A plurality of channels are fixed, preferably with a predefined spacing, on the two profiles intended to be inserted in the opposite uprights of the door or window. Even more preferably, with parts assembled, the ends of the flexible tongues, when at rest, touch the two uprights, at different points of the uprights.

Instead, in the operative compression phase, the flexible tongue is bent and the distance in transverse direction of its distal end with respect to the profile (or to a plane comprising the flank of the channel) is reduced.

In a preferred embodiment of the present invention, the at least one flexible tongue is curved at rest. In particular, the tongue forms a chute having a maximum height at the distal end and minimum height at the proximal end, where it is substantially coplanar with the flank of the channel. The height of the chute formed by the flexible tongue, and therefore its curvature, vary depending on the cushioned load until a state of maximum compression is reached where the chute is flattened and is substantially coplanar with the flank of the channel.

It is quite possible for the flexible tongue to be shaped differently when at rest, for example as a straight section, extending in the longitudinal direction with respect to the flank of the channel, with a predefined angle relative thereto, and assuming a varyingly accentuated curvature depending on the cushioned load following the varyingly accentuated movement of the profile towards the upright.

Similarly, it is quite possible for the flexible tongue to have a different curvature when at rest, for example to have the shape of an overturned chute, namely to have an opposite concavity with respect to the concavity of the chute described further above.

In particular, in one embodiment, said at least one flexible tongue is concave upwards with respect to a surface of the channel to which it is fixed. In another embodiment said at least one flexible tongue is concave downwards with respect to a surface of the channel to which it is fixed. Other curvatures of the tongue fall within the scope of protection of the present invention.

Preferably, in the various embodiments, the at least one flexible tongue is coplanar with a surface of the channel on which it is fixed, in a working phase of maximum cushioning between the profile and the frame.

Advantageously the Applicant has obtained very satisfactory results by means of the use of plastic material for the flexible tongue. Preferably the channel is also made of plastic material. Even more preferably the channel and the tongue are formed as one piece.

According to a particularly advantageous aspect of the present invention, the cushion comprises a first flexible tongue projecting from one side of the channel and a second flexible tongue projecting from an opposite side of the channel.

Each of said first and second tongues may be formed in accordance with that which has already been mentioned. For example both tongues may have a curvature directed upwards. The two flexible tongues may be two chutes directed towards the same flank, to which they are fixed by means of the respective proximal ends, substantially coplanar with the flank.

It is quite possible for the shape of the tongues to be different, for example in terms of curvature. Likewise it is possible for the tongues to have the same concavity, but with a different slope or opposite concavity (one directed downwards and one directed upwards), or for one tongue to be straight and extend obliquely in relation to the flank and the other tongue to be curved.

In a preferred embodiment of the invention the two tongues are symmetrical. Preferably the tongues have the same length and/or the same curvature.

According to one aspect of the present invention the tongues are arranged in the manner of bull's horns, with the proximal ends fixed to the channel, i.e. to a flank thereof.

The channel comprises a bottom intended to touch a rib of the profile and two flanks. At least one of the flanks, preferably the flank on which the flexible tongue is not fixed, comprises a flange or protrusion directed towards the interior of the channel, intended to be inserted in a groove of the profile for rapid engagement.

One flank, preferably the flank with the flange, is inclined towards the opposite flank, reducing the breadth of the opening of the channel with respect to the bottom, when at rest.

The channel does not have a cushioning function. The channel ensures rapid engagement with the profile.

The present invention solves the technical problem disclosed above also by means of a profile of a shade for a door or window, comprising a plurality of cushions of the type described above, the cushions being spaced, preferably with a predetermined spacing. The cushion is provided with a groove along its entire length or at predetermined points, said groove being intended to receive the tip of the flange of the cushion. According to one embodiment, the groove is on the cushion and the tip on the profile.

According to one aspect of the present invention the thickness of the profile is smaller along predetermined sections where the cushions are mounted. Along said predetermined sections the profile defines seats which are closed by mounting of the cushion in such a way that, when the parts are assembled, the surface of the profile on the sides of the cushion is coplanar with the flank of the cushion from where the flexible tongue projects. Advantageously, according to this aspect of the present invention, the profile, in a working phase of total compression of the flexible tongue, is substantially touching the upright. Advantageously neither the flexible tongue nor the channel forms an impediment and encumbrance between the profile and the upright.

The technical problem disclosed above is also solved by a shade system comprising a frame which includes two opposite uprights for receiving a respective profile of a shade and two profiles inserted in the uprights, each of the profiles comprising a plurality of cushions, preferably with a predefined and optionally variable spacing.

Finally the technical problem is also solved by a method for performing cushioning between a profile and an upright according to the present invention comprising the steps of:
preparing a profile of a shade for a door or window;
mounting on a rib of the profile a plurality of cushions, each one comprising a channel, mounted on the rib of the profile and having a substantially C-shaped cross-section, and at least one flexible tongue on the channel, intended to provide a cushioning action between the profile and a frame for assembly of the profile,
   said at least one flexible tongue extending in the longitudinal direction (L) of the channel and projecting outside thereof on at least one respective side;
inserting the profile in the upright with the corresponding cushions directed towards the upright.

Further characteristic features and advantages of the present invention will become clearer from an example of embodiment thereof provided purely by way of a non-limiting example with reference to the accompanying drawings.

### BRIEF DESCRIPTION OF THE ACCOMPANYING DRAWINGS

FIGS. 1 and 1a are a detail of a profile A (FIG. 1) and a front-end section thereof (FIG. 1a).

FIG. 2 is a perspective view from above of a cushion according to the present invention.

FIGS. 3a and 3b are side views of the cushion of FIG. 1.

FIG. 4 is a rear view of the cushion of FIG. 1.

FIG. 5 is an enlarged detail of the view of FIG. 2b.

FIG. 6 is a perspective view from below of the cushion according to the present invention.

FIGS. 7a-7c are a front, side and perspective view of the cushion according to an embodiment of the present invention.

FIGS. 8a-8b are a perspective view and a side view of the cushion of FIG. 2, mounted on a profile, according to the present invention.

FIGS. 9a-9b are the perspective view and the side view of the cushion of FIG. 2, mounted on the profile and in a different working phase with respect to FIGS. 8a, 8b.

FIG. 10 is a perspective view of the cushion of FIG. 2, mounted on a profile inserted in an upright, according to the present invention (the portion of the upright in the region of the cushion is shown cut-away).

FIG. 11 is a perspective view of the cushion of FIG. 2, mounted on a profile for a light-screening or curtain system, according to the present invention.

FIG. 12 is a perspective view of the cushion of FIG. 2, mounted on a profile for a fly screen, according to the present invention.

FIGS. 13a-13b are front-end views of a cushion, mounted on a removable edge of the upright.

FIG. 14 is a front-end sectioned view of the cushion, removable edge and upright of FIGS. 13a-13b.

FIG. 15 is a perspective, partially cut-away view of the cushion, removable edge and upright of FIGS. 13a-13b.

FIG. 16-19 are prospective views of the cushion and profile according to the present invention.

FIGS. 20a-20c are respectively, a lateral view, a cross section and a top view of the cushion of FIG. 16.

FIG. 21 is a lateral view of the cushion of FIG. 18.

FIG. 22 is a lateral view of the cushion of FIG. 17.

FIG. 23-25 are different embodiment of the cushion according to the present invention.

### DETAILED DESCRIPTION

With reference to the accompanying drawings, some embodiments of the cushion and of the profile of a shade of a door or window according to the present invention are described below.

In the following description the term “shade” comprises any accessory designed to control the light and/or the air passing through a door or window. For example, and without claiming to be exhaustive, the shade may be a curtain, a fly screen, a louver system, each one having a specific function along the door or window, such as for example partial or total screening of light by reducing, with vertical or horizontal sliding, the light section of the door or window (curtain), protection against insects by total closure of the section of the door or window, but without light-screening effect (fly net), or partial or total screening of light by reduction, with horizontal slats, of the entrance openings for the light via the door or window (louvers).

Moreover, in the description given and within the scope of the present invention, the term “door or window” comprises any opening on the walls of a building, whether built in brick, wood or other material. For example, again only by way of example, the door or window comprises entrance doors, windows or ventilation and illumination openings, French doors for access to balconies, etc. etc.

With reference to FIGS. 16-25, it is disclosed a cushion 1 according to an embodiment of the present invention, and more particularly a cushion 1 for a profile 100 of a shade of a door or window, for cushioning between the profile 100 and a frame 1000 for assembly of the profile.

The shade 500 is also represented in more detail with reference to FIG. 10, and has an edge 501 slidingly associated with the profile 100. The profile 100 is inserted in an upright 1000 of the frame of the door or window and comprises a seat S for the edge 501 of the shade 500, for example of a blind 500.

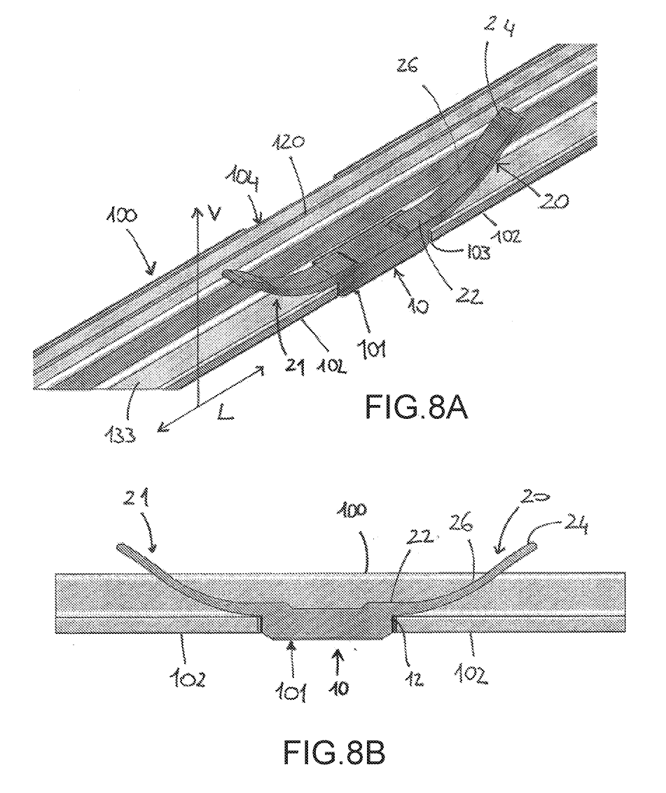

More particularly, during assembly, the edge 501 of the shade 500 is slidingly insertable in the seat S through a side opening of the profile, leaving the rest of the shade 500 to project from the seat S (and from the upright) through a front slit 120 (see also FIGS. 16, 8a and 9b for the slit) of the profile 100, which has a breadth smaller than the edge 501 of the shade 500, in order to restrain the edge 501 in the seat S.

The opposite edge of the shade 500 is similarly associated with a profile 100 of the other upright 1000 of the frame (not shown). When the air acts on the surface of the shade 500, the shade moves the profile 100 between the uprights 1000.

According to the various uses, the shade 500 can be retracted totally or partially from the door or window to allow the passage of light or air (depending on the function for which the shade is designed) or extended along it, in order to block out light or reduce the passage of air. The sliding action is for example of sliding-shutter type, in which case the shade 500 slides along a pair of uprights 1000, associated with a frame of the door or window or incorporated therein.

The uprights 1000 may be perpendicular to the floor and the shade 500 slidable vertically. In some cases the uprights are instead horizontal and the shade 500 slides horizontally. The profile 100 may have the same length as the upright 1000 and is restrained in a thickness 1005 of the upright 1000, which facilitates the horizontal movement of the shade (in the case of a horizontally sliding shade) or vertical movement (in the case of a horizontally sliding shade).

Still with reference to FIG. 16-25, in use, the cushion 1 may be not fixed to the profile 100 or to the upright 1000 (frame) but free to move in a space S between the upright and the profile 100. More particularly, depending on the size of the cushion and the frame, the cushion may move in a vertical direction, between a surface of the profile 100 and a surface of the frame which is parallel to the profile surface (direction S in FIG. 16) and/or to move in a horizontal direction, for instance along the profile.

When the profile is assembled to the frame, the cushion cannot escape from the space delimited from the profile surface and the frame surface. Also, the size and/or shape of the cushion is chosen, depending on the size of the space above referred, to avoid misplacements from a correct working position, in which a surface of the cushion is faced to the profile surface and at least an end portions of the cushion is faced to the frame surface. In other words, once the cushion(s) is applied in the correct position, it is not allowed to rotate on itself, due its size with respect to the size of the space between profile and frame.

For instance, a distance between a second surface 100b of the profile which is perpendicular to the profile surface 100a, and a second surface 1000b of the frame which is perpendicular to the frame surface 1000a is less than a height of the cushion at rest.

The cushion 1 of FIG. 16 has a U shape with a predetermined curvature at rest, and two end portions 24. The end portions 24, in use, are towards the upright surface, and the portion 300 in the middle between the end portions is towards the profile surface. Depending from the application, the U shape may be nor symmetric and, in such a case, the base portion of the cushion is not at the middle thereof.

In absence of compression, the end portions 24 and the middle portion 300 may contact the respective surfaces, but the shape of the cushion is not deformed with respect to its shape at rest. Instead, when the profile 100 is moved towards the upright (directions a in FIG. 16), for instance due to the wind, the predetermined curvature of the cushion 1 is changed, due to elastic deformation, and is completely flattened or brought to a reduced curvature.

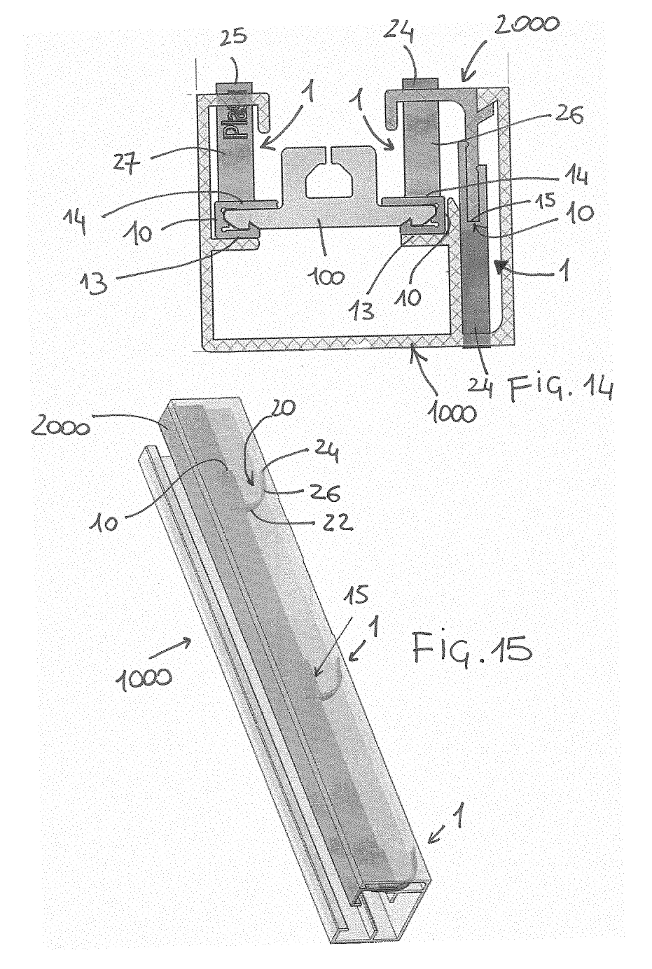

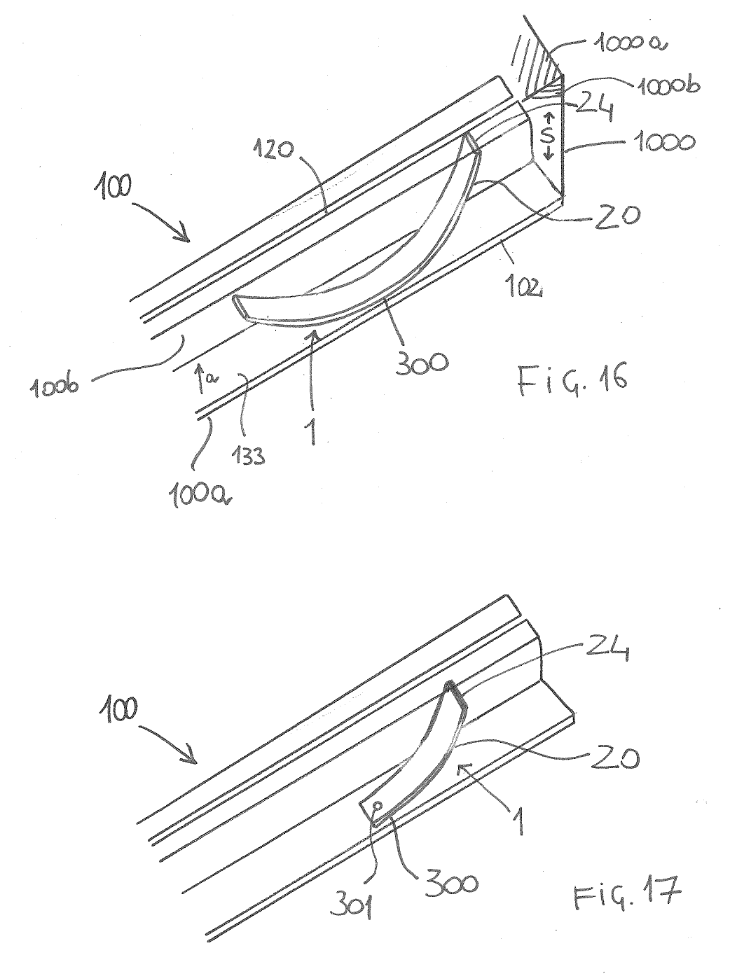

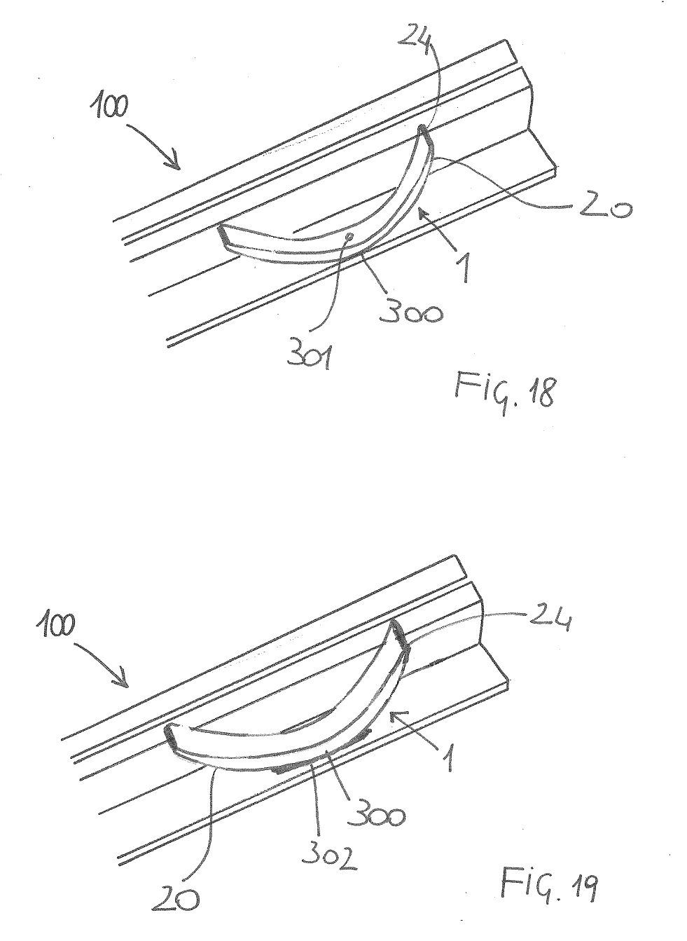

With reference to FIGS. 18 and 19, it is schematically represented an embodiment of the cushion wherein means 301, 302 to couple the cushion to the profile 100 are provided. The coupling means prevents one cushion 1 from contacting another cushion on the same side of the profile, i.e. maintain the cushion at a predetermined position on the profile. The coupling means of FIG. 18 is a pin on the cushion 1, projecting from the outer surface of the middle portion thereof, and locked in a hole of the profile 100. In another embodiment as schematically represented in FIG. 19, the means for coupling is a glue 302 on a surface of the profile 100, between the profile and the cushion.

Although in FIG. 16, 18-19, just one side 100a (or flange 133) of the profile 100 is represented, another and counter posed side may be provided to apply other cushions, so as to arrange the cushions at a predetermined distance on the both sides of the profile.

The cushion 1 comprises a flexible tongue 20, preferably a U-shaped tongue and a surface 300 of the tongue 20 is directly faced to the profile 100, i.e. with no means interposed between the surface 300 of the tongue and the profile 100. For instance, the tongue 20 is attached to the profile 100 by means of glue or a locking pin, as represented in FIG. 19.

In FIG. 17 it is schematically represented a tongue having a base portion 300 associated to the profile 100, for instance coupled through a pin/hole coupling in the profile, and only one end portion 24 directed towards the upright is used.

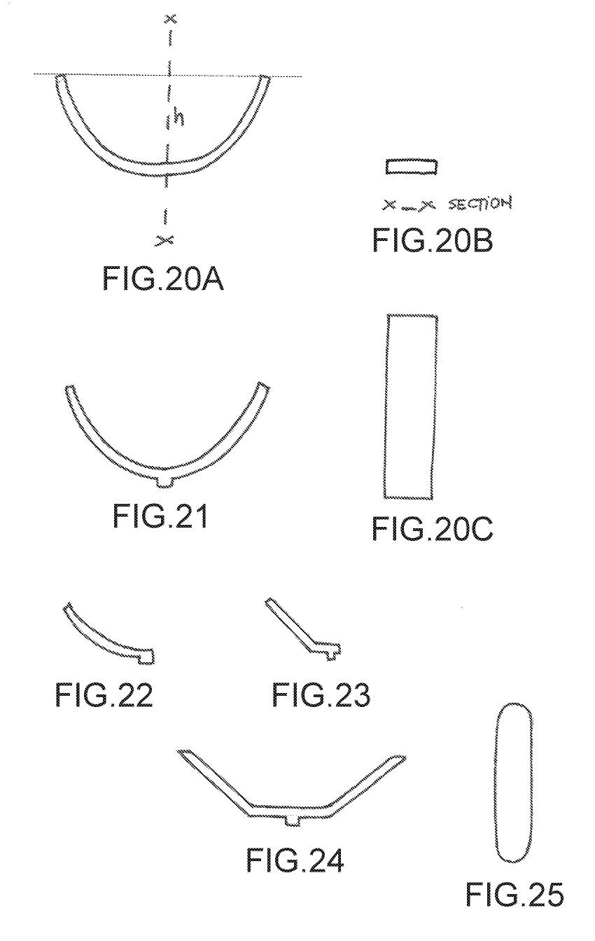

Different embodiments of the cushion are covered by the present application. For instance, and without limitations, the cushion of FIG. 23 has a flexible tongue which is not curved but inclined with respect to the base portion, wherefrom a pin projects at the bottom. The cushion of FIG. 24 has two tongues extending from opposite side from the base portion, wherefrom the pin projects at the bottom. The cushion of FIG. 25 (top view) has curved end portions, adapted to avoid gripping on the frame surface. FIG. 20a-20c are different views of the cushion of FIG. 16.

According to other embodiments of the present invention the cushion 1 comprises a first portion 10 able to be mounted on a first section 101 of the profile 100 and a second portion 20 which acts as cushion between the upright 100 and a second section 102 of the profile 100. Again referring to FIG. 10, given solely by way of example and with reference to a specific embodiment of the invention, the cushion 1 is visible through a portion 1010 of the upright 1000 shown in cut-away form.

In FIG. 10 the cushion 1 is at rest and has a distal end 26 of the second portion 20 in contact or in the proximity of, i.e. very close to, to a surface 1020 of the upright 1000. In this working phase the second portion is not deformed.

In FIG. 8a the cushion 1 is shown alone on the profile 100 and the first 101 and the second section 102 are clearly indicated. The first section 101 and the second section 102 of the profile 100 may be different or partially overlapped.

For example the first portion 10 of the cushion may be mounted on a first section 101 of the profile and the second portion 20 is connected to one end 12 of the first portion 10 and is intended to operate along a second section 102 of the profile which is completely free from the first portion 10.

However the second portion 20 of the cushion may comprise a first part 22 which exercises its cushioning function already at one end 12 of the first section 101 of the profile and a second part 26, 24 which exercises its cushioning function along the second section 102 of the profile.

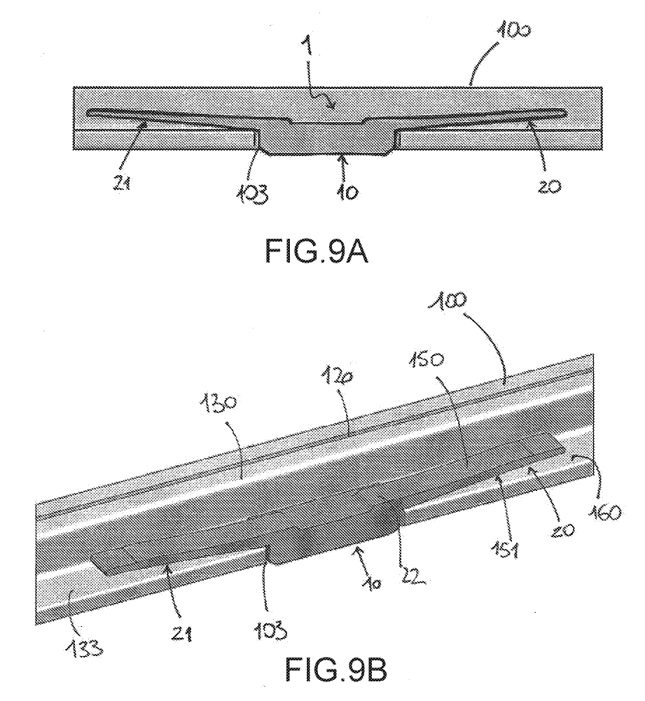

Preferably one end 22 of the second portion 20 is coplanar with a surface of the first portion 10. More particularly the first portion 10 has a flat surface 14 intended to remain in contact with an upper surface 160 (FIG. 9b) of the profile and the end 22 of the second distal portion 20 is coplanar with the surface 14 or slightly raised or sloping with respect thereto.

Advantageously, according to the proposed solution disclosed above, during maximum compression, the second portion 20 of the cushion 1 does not constitute an encumbrance between the profile 100 and the upright 1000. Preferably, during said compression phase, the second portion 20 is touching or very close to the profile 100.

FIG. 9b shows schematically the cushion 1 during maximum compression or in any case in a very compressed condition. In this drawing the upright 1000 has been omitted only in order to highlight more clearly the features of the profile 100 and the cushion, forming the subject of the invention, but it is obvious that the upright 1000, and more particularly the surface 1020, serves to compress the cushion 1 between upright and profile 100, and to reach the position of FIG. 9b.

FIGS. 8b and 9a are side views of FIGS. 8a and 9b, respectively. In relation to these drawings, again given solely by way of example, these show a profile 100 according to the present invention provided with a central section 130 which forms the seat S for the edge 501 of the shade 500. The central section 130 has a base 131 and two flanges 133 which extend from the base 131, coplanar therewith, which form the opposite edges 101, 102 of the profile 100, on which the cushions 1 are mounted.

These edges 101, 102 comprise recesses 103, 104, which are preferably equally spaced along the edge or with a predefined, optionally variable spacing, and which form points for insertion of the first portion 10 of the cushion 1. In the region of said recesses 103, 104 and under the base 131 of the profile (more particularly under the flanges 133) or preferably along the entire base of the profile (again under the flanges 133) grooves 132 with a longitudinal extension L are provided, these forming seats for rapid engagement of the cushions 1.

In one aspect of the present invention the thickness of the profile 100 is smaller in the region of the recesses where the cushions are mounted. In said recesses the profile defines seats which are closed by mounting of the cushion in such a way that, when the parts are assembled, the surface of the profile on the sides of the cushion is coplanar with the flank of the cushion from where the flexible tongue projects. Advantageously, according to this aspect of the present invention, the profile, in a working phase of total compression of the flexible tongue, is substantially touching the upright. Advantageously neither the flexible tongue nor the channel forms an impediment and encumbrance between the profile and the upright.

Depending on the type of shade 500 used, a specific mounting arrangement of the cushions 1 is foreseen.

Preferably, for the shades subject to lower stresses, for example for fly screens which allow air to pass through even when closed, the cushions 1 are mounted alternatively on the opposite edges 101, 102 of the profile.

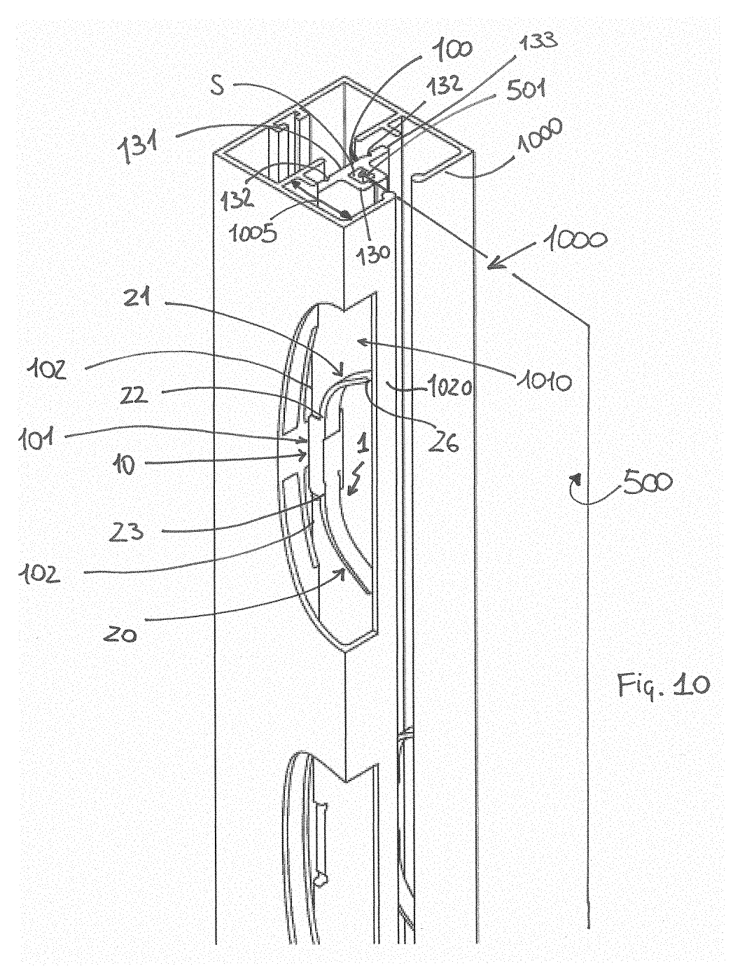

For example, referring to FIG. 11, a cushion 1 is mounted in a recess 103 of an edge 101 of the profile 100, starting from one end A of the profile 100. Proceeding towards the second end of the profile 100 a second cushion 1 is mounted along a recess 104 of an edge 102 opposite to the edge 101 on which the first cushion 1 is mounted. Opposite the recess 104, on the opposite edge 101, there is a recess 103-x but this recess 103-x is not engaged by a cushion 1. Similarly, opposite the recess 103, on the edge 102, there is a recess 104-x and this recess is not engaged by a cushion 1.

Still in the direction towards the second end B of the profile 100, a third cushion 1 is mounted in a recess 103a of the edge 101. At the groove 103a, on the edge 102, there is a recess 104-x not engaged by a cushion 1.

Preferably, in the case of shades subject to greater stresses, for example light-screening curtains which may even totally prevent the passage of air, a greater number of cushions are mounted. FIG. 12 shows an exemplary embodiment in which a respective cushion 1 is mounted in each recess 103 and 104 of the edges 101 and 102.

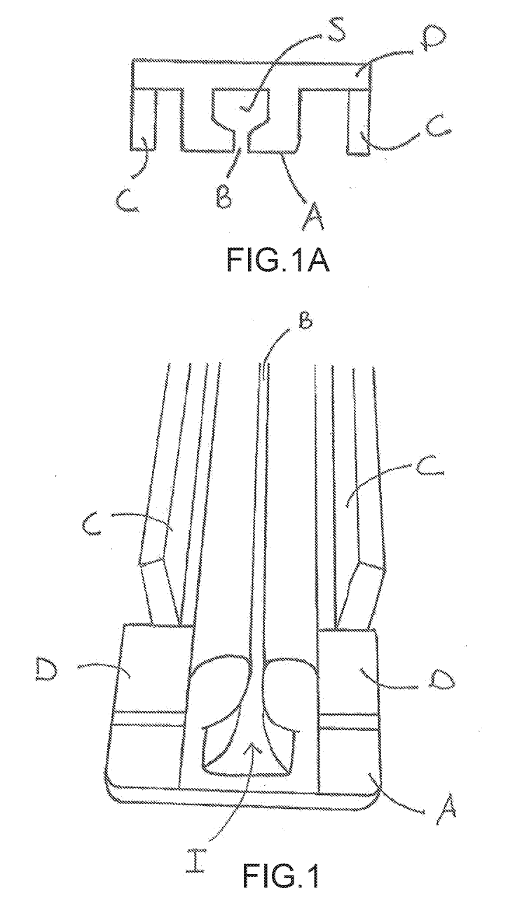

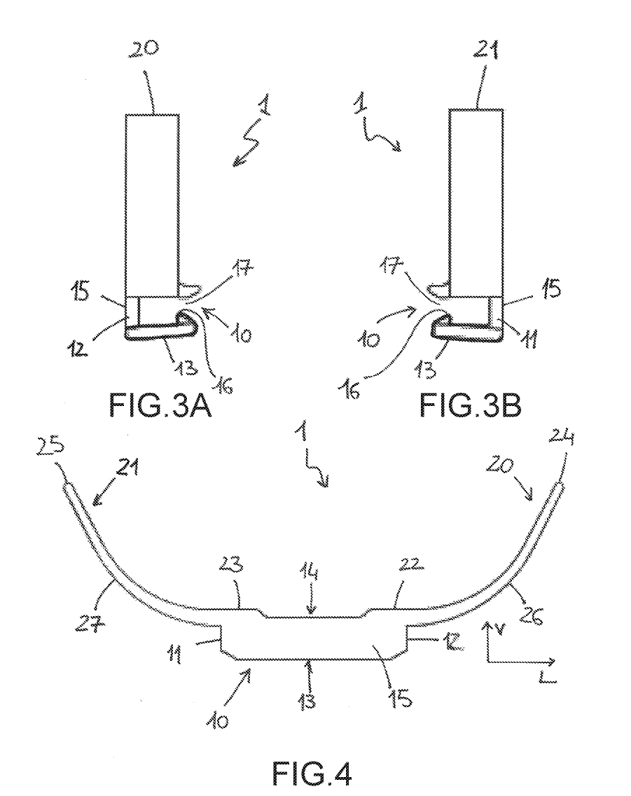

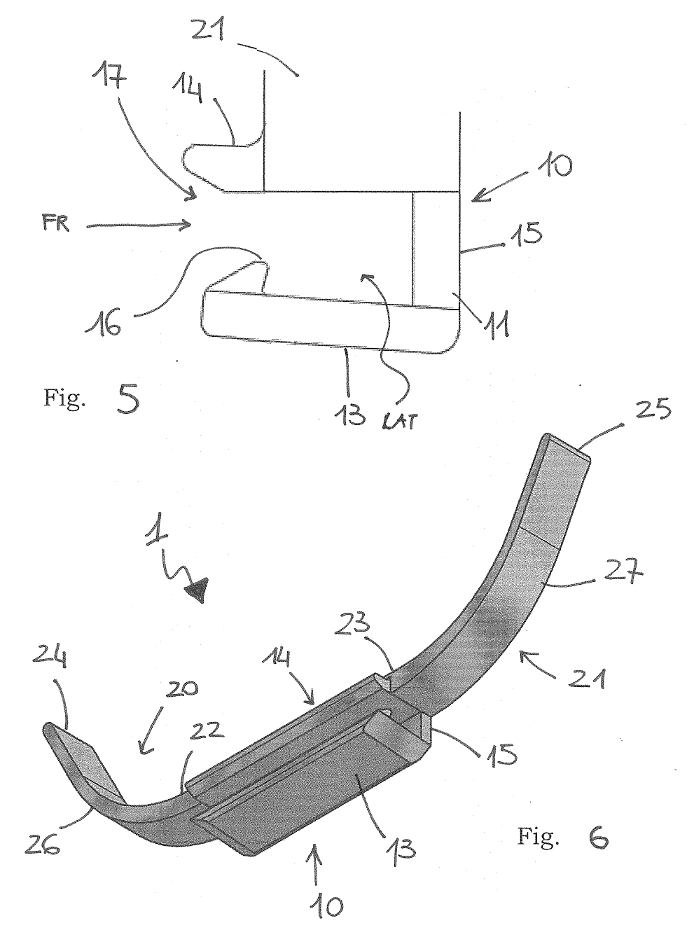

With reference to FIGS. 1-7, some specific embodiments of the cushion 1 according to the present invention are described below.

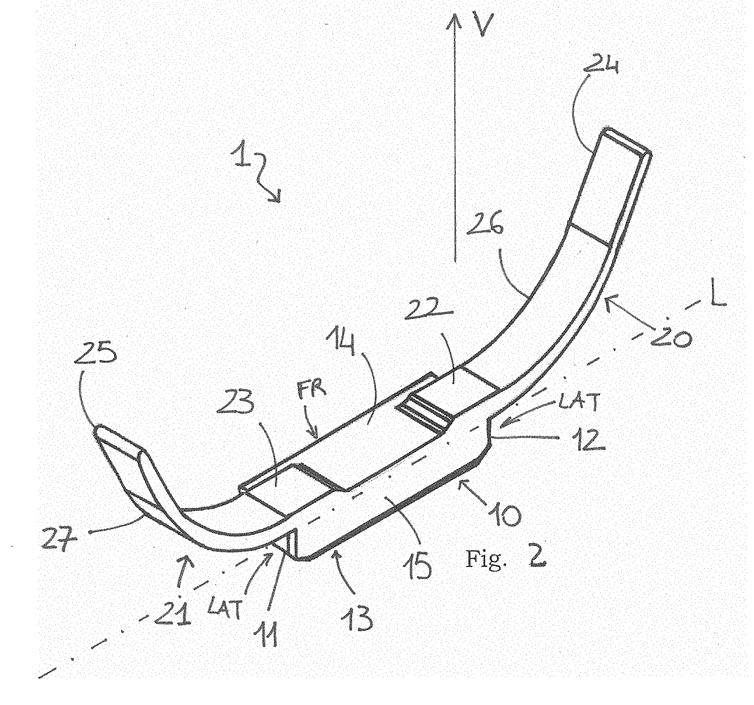

In particular, as shown in FIG. 2, the first portion 10 may be a channel 10 which can be mounted on the first section 101 of profile 100 and the second portion 20 may be a flexible tongue 20 with one end 22 on the channel 10, which extends outside the channel 10, at least in the longitudinal direction L of the channel 10.

More particularly the flexible tongue 20 is on one face 14 of the channel 10 and extends in the direction L along which the profile 100 extends, beyond the lateral opening LAT of the channel. Again more particularly the channel 10 has a front opening FR and two opposite lateral openings LAT and said at least one flexible tongue 20 extends beyond the lateral openings or opening LAT of the channel 10.

According to a preferred embodiment of the present invention, the cushion 1 for a profile 100 of a shade 500 of a door or window comprises a channel 10 which can be mounted on the profile 100, having a substantially C-shaped cross section, and at least one flexible tongue 20, 21 on the channel 10, which acts as cushion between the profile 100 and a frame 1000 (or upright) for assembly of the profile 100, and is characterized in that said at least one flexible tongue 20, 21 extends in the longitudinal direction L of the channel 10, projecting outside thereof on at least one side 11, 12.

In particular, the flexible tongue 20 projects beyond the opening LAT or the lateral openings LAT of the channel.

Advantageously, projecting outside of the channel, the tongue acts as cushion on a section 102 of the profile on which the channel 10 is not mounted and allows the profile 100 to come very close to the upright 1000, during compression of the tongue.

The flexible tongue 20, 21 preferably has a proximal portion 22, 23 fixed on the channel 10 and a remaining portion 24, 25, 26, 27 projecting from the channel 10 also in a vertical direction V, so as to be spaced from the channel 10.

More particularly, at rest, i.e. when there is no action exerted by the air or a user on the shade 500, a distal end 24, 25 of the flexible tongue is spaced both in a longitudinal direction (L) and in a transverse direction (direction V) from the channel 10.

Preferably, when the parts are assembled, in the rest position, the end 24 of the flexible tongue 24, 25 touches the upright 1000.

In one embodiment the tongue at rest does not touch the upright and a space of one or more millimetres is left between the upright and the profile.

A plurality of channels 10 are fixed, preferably with a predefined spacing, on the two profiles 100 intended to be inserted in the opposite uprights of the door or window.

Even more preferably, when the parts are assembled, the ends of the flexible tongues, when at rest, touch the two uprights, at different points of the uprights.

Instead, during the working compression phase, the flexible tongue 20 is bent and the distance in the transverse direction (V) of its distal end 24, 25 with respect to the profile 100 (or to a plane comprising the flank 14 of the channel 10) is reduced.

In one embodiment, the tongue 20 during maximum compression is touched along its upper surface 151 by the upright 1000 and along its lower surface 151 by the profile 100, in particular by an upper surface 160 of the flange 133 which extends beyond the base 131 of the central section 130 of the profile 100. The upper surface 160 is situated opposite to the surface in which the groove 132 which forms the seat for rapid engagement of the cushion 1 is provided.

In a preferred embodiment of the present invention, the at least one flexible tongue 20, 21 is curved at rest. More particularly the tongue forms a chute having maximum height at the distal end 24 and minimum height at the proximal end 22, where it is substantially coplanar with the flank 14 of the channel or slightly raised and/or slightly inclined with respect thereto. The height of the chute formed by the flexible tongue, and therefore its curvature, vary depending on the cushioned load until a state of maximum compression is reach where the chute is flattened and is substantially coplanar with the flank 14 of the channel 10.

It is quite possible for the flexible tongue to be shaped differently when at rest, for example as a straight section, extending in a longitudinal direction with respect to the flank 14 of the channel, at a predetermined angle with respect thereto, assuming a varyingly accentuated curvature depending on the cushioned load following the varyingly accentuated movement of the profile towards the upright.

Similarly, it is quite possible for the flexible tongue to have a different curvature when at rest, for example to have the shape of an overturned chute, namely to have an opposite concavity with respect to the concavity of the chute described further above.

In particular, in one embodiment, at least one flexible tongue 20, 21 is concave upwards with respect to a surface 14 of the channel 10 to which it is fixed. In another embodiment at least one flexible tongue 20, 21 is concave downwards with respect to a surface 14 of the channel 10 to which it is fixed. Other curvatures of the tongue fall within the scope of protection of the present invention.

Preferably, in the various embodiments, the at least one flexible tongue 20, 21 is coplanar with a surface 14 of the channel 10 on which it is fixed, in a working phase of maximum cushioning between the profile 100 and the frame 1000.

Preferably the cushion 1 is made of plastic material and the channel and the tongue are formed as one piece. In one embodiment the material for the flexible tongue 20, 21 is plastic and is different from the material used for the channel. Preferably the channel is also made of plastic material.

According to a particularly advantageous aspect of the present invention the cushion comprises a first flexible tongue 20 projecting from a side 12 of the channel 10 and a second flexible tongue projecting from an opposite side 14 of the channel 20, according to that shown, for example, in FIGS. 2 to 4.

Each of the two tongues may be formed in accordance with that which has already been mentioned. For example both tongues may have a curvature directed upwards. The two flexible tongues may be two chutes directed towards the same flank 14, to which they are fixed by means of the respective proximal ends 22, 23, substantially coplanar with the flank 14.

It is also quite possible for the shape of the tongues to be different, for example in terms of curvature. It is likewise possible for the tongues to have the same concavity, but with a different slope or opposite concavity (one directed downwards and one directed upwards), or for one tongue to be straight and extend obliquely with respect to the flank 14 and the other tongue to be curved.

In a preferred embodiment of the invention the two tongues are symmetrical. Preferably the tongues have the same length and/or the same curvature.

According to one aspect of the present invention the tongues are arranged in the manner of bull's horns, with the proximal ends fixed to the channel, i.e. to a flank 14 thereof.

The channel comprises a bottom 15 intended to touch a rib of the profile 100 and two flanks 13, 14. At least one of the flanks, preferably the flank 13 on which the flexible tongue 20, 21 is not fixed, comprises a flange 16 or protrusion directed towards the interior of the channel 20 and intended to be inserted in a groove 132 of the profile 100 for rapid engagement. According to one embodiment the groove is on the cushion and the tip on the profile.

One flank 13, preferably the flank with the flange 16, is inclined towards the opposite flank 14, reducing the breadth of the opening 17 of the channel 10 with respect to the bottom 15, when at rest.

The channel does not have a cushioning function. The channel ensures rapid engagement with the profile.

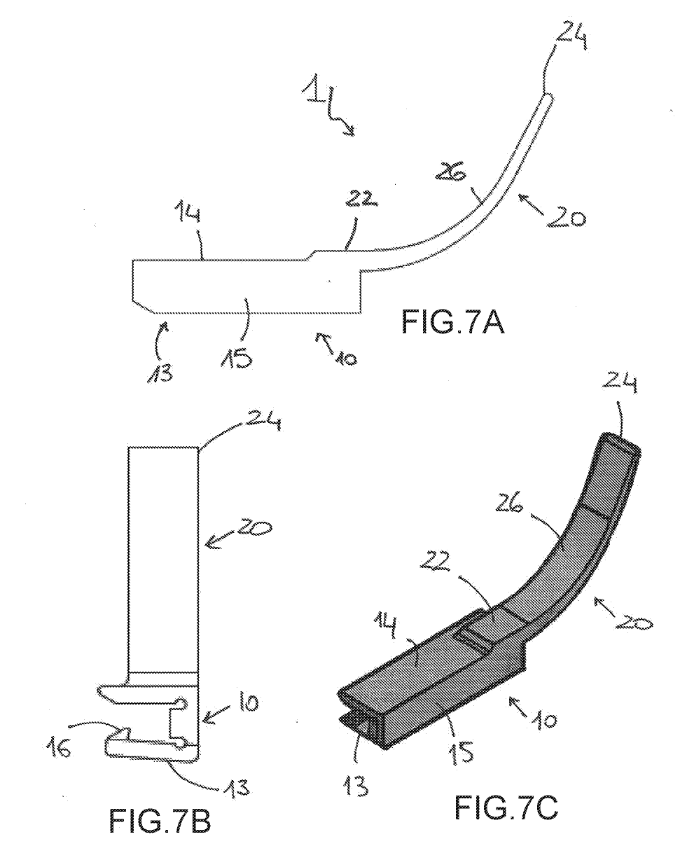

In one embodiment, shown schematically in FIGS. 7a-7c, a single tongue is provided, extending from one side only of the channel, beyond the lateral opening LAT.

According to one aspect of the present invention the cushion comprises two flexible tongues, as for example shown in FIG. 6, and one flexible tongue has greater elasticity than the other flexible tongue.

Advantageously a different elasticity of the two tongues allows an improvement in the pretensioning of the shade associated with specific doors or windows, for example it allows an improvement in the pretensioning of the oblique sliding shades. In fact one flexible tongue, namely the one intended to be mounted towards a tendentially looser portion of the shade (screen)—which therefore has a greater bowing or concavity—may have greater elasticity and therefore extensibility, while the tongue intended to operate towards a tendentially tauter portion of the shade (screen)—which therefore has a smaller bowing or concavity—may have a smaller elasticity and therefore smaller extensibility. A similar technical effect, according to the present invention, can be obtained using two flexible tongues of equal elasticity, but with a different curvature or extension at rest. Similarly, for specific installations, it is possible to envisage that the cushions intended to be mounted on an edge of the profile may have flexible tongues with a greater elasticity than the elasticity of the flexible tongues on the other edge of the profile or it is possible to envisage that the cushions intended to be mounted on a profile (i.e. on both its sides) may have flexible tongues with a greater elasticity than the elasticity of the flexible tongues on the other profile (i.e. on both its sides). The different elasticity of one tongue with respect to the other is preferably marked visibly, for example by means of respective colouring or numbering. A cushion may have two tongues of different colour.

Advantageously, again and only as an example with reference to FIG. 6, each cushion forms at least two points or zones of contact with the upright. These zones of contact may be only two points, at the ends of the flexible tongues, in the state of maximum extension of the flexible tongues, or may involve a more extensive portion of the tongues, which is all the greater the higher the compression.

Such a configuration creates optimal pretensioning and cushioning. In fact, at rest, the distal ends of the opposite flexible tongues associated with a plurality of cushions can form a plurality of points for contact and pretensioning corresponding to a respective plurality of matching points on the surface of the upright, without however involving the whole surface of the upright. In the working phase, the greater the compression, the greater (more extensive) may be the zone of contact of the flexible tongues of said plurality of cushions with respective zones of contact on the surface of the upright.

Advantageously, the cushions of the present invention, more particularly the cushions of FIG. 6, may be mounted on both sides of the profile.

The cushion 1 according to the present invention is particularly advantageous also in the arrangement for mounting thereof between the upright 1000 and an extractable edge of the upright.

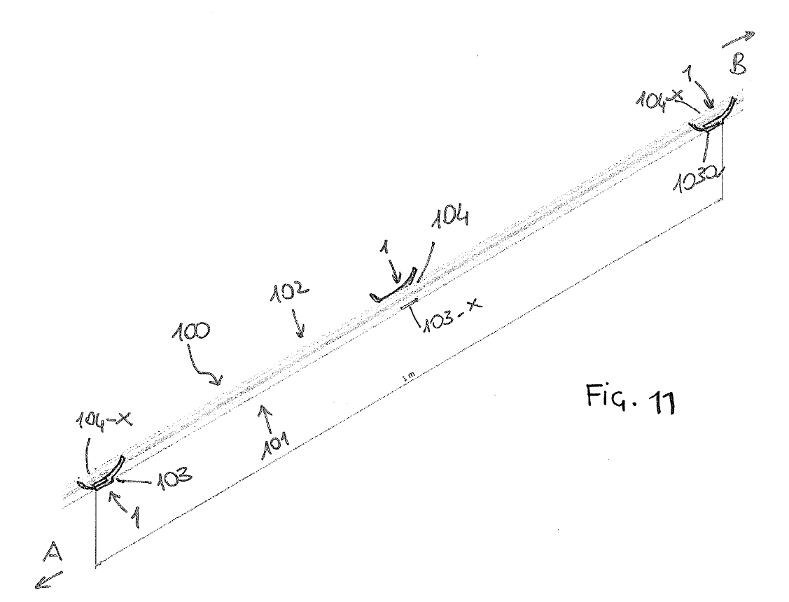

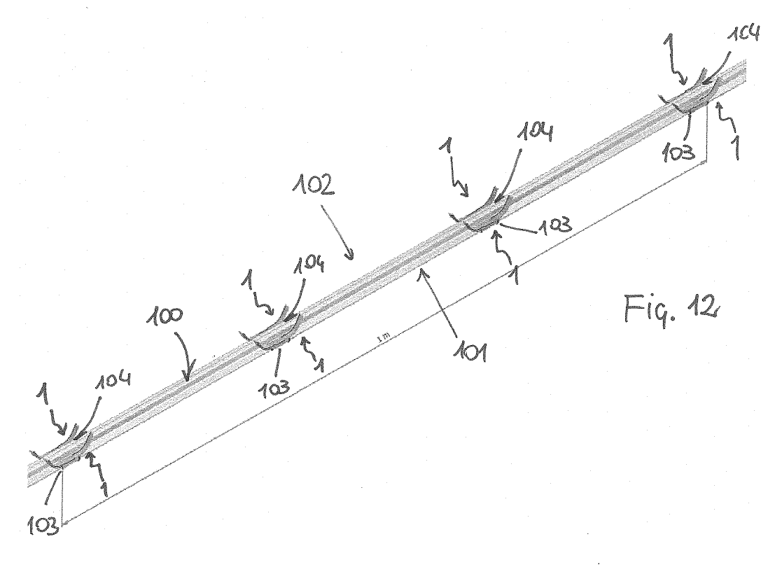

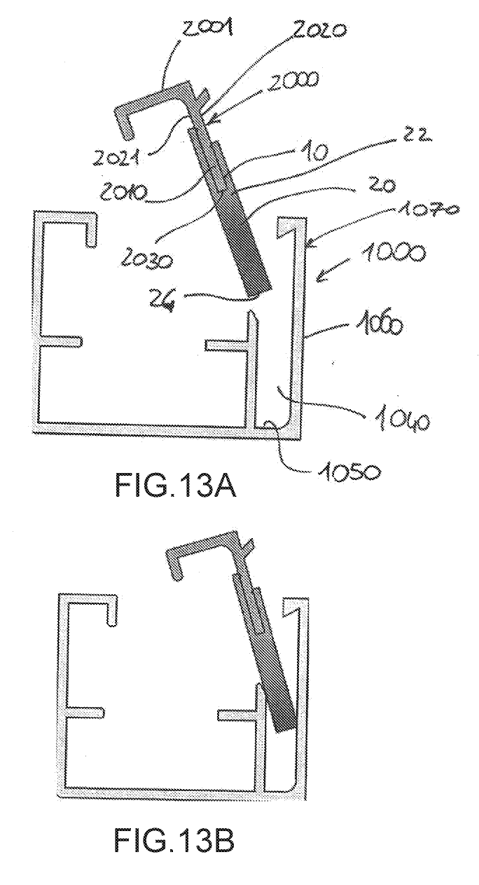

With reference to FIGS. 13a-13b, an upright 1000 is shown schematically, comprising a removable rib 2000 which can be engaged by means of a quick fit, for example snap-engagement, in the upright, said rib being structured to form a profile for restraining the profile 100 inside the upright and a face of the upright without holes.

The removable rib 2000 is inserted in a seat 1040 or channel which extends longitudinally along the upright 1000, on one of its flanks 1060, and inside which seat elastic means operate, situated between the rib 2000 and the bottom 1050 of the upright, said elastic means restraining the rib between the bottom and the flank 1060.

Advantageously assembly of the removable rib 2000 is performed by fitting the rib 2000 inside the seat 1040, without screws, and disassembly is performed by extracting the rib from the seat, with a simple manoeuvre involving compression of the elastic means. No hole is provided on the face of the upright bounded by the removable rib. Moreover the upright can be installed flush with the wall situated alongside a window, with the bottom of the upright inset in the wall and the face of the upright flush, or so as to form so-called continuous façades. In this case the upright is placed between two neighbouring openings and forms two seats for two profiles, a first profile associated with a shade which extends in a first direction, to cover a first opening of the continuous façade, and a second profile associated with another shade which extends in a second direction, so as to cover a second opening of the continuous façade of a building.

At least one of the flanks 1060 is associated with the removable rib 2000, and elastic means are arranged between the removable rib and a bottom of the upright, in order to restrain the rib between the bottom and the flank.

Advantageously, according to the present invention, the elastic means are formed by the cushion 1. The flank associated with the removable rib comprises a lateral wall and a shoulder, substantially parallel to the lateral wall, which forms, with the bottom of the upright, the seat for receiving the rib inside which the cushion 1 operates, pushing the rib from the bottom of the upright towards an abutment on the flank.

According to this aspect of the invention the cushion 1 comprises a channel, with a substantially C-shaped cross-section, mounted or able to be mounted on an edge 2010 of the removable rib 2000, and a flexible tongue 20, having one end 22 on the channel 10 and an opposite end 24 spaced from it and touching the bottom 1050 of the upright. Advantageously a plurality of cushions 1 may be easily and rapidly mounted on the edge 2010 of the channel, with a predefined or variable spacing from each other, in order to exert a pressure along the whole rib 2000, improving fixing inside the upright 1000.

The flank 106 may comprise a rigid side-wall and the removable rib 2000 is engaged so as to be inset relative to the rigid side-wall. The rigid side-wall forms one side of the upright and is formed as one piece with the upright. The removable rib 2000 comprises a face 2001 which defines a front profile of the upright and a lateral wall 2020 perpendicular to the face, comprising the edge 2010 on which the cushions are mounted. The lateral part of the rib substantially has the same length as the face but, advantageously, may be narrower than the face, owing to the presence of the cushions between bottom and rib. The rib made in this way is easier to assemble also due to the reduced width.

Preferably a plurality of cushions are mounted with predefined or variable spacing on the edge of the removable rib. The spacing is preferably comprised between 15 cm and 20 cm.

In one embodiment the cushion 1 to be mounted on the edge of the removable rib 2000 has a channel with the parallel flanks 13, 14, intended to remain in contact with the opposite sides 2020, 2021 of the removable rib 2000, and a bottom 15 which touches, when the parts are assembled, one end 2030 of the removable rib 2000. The cushion 1 comprises at least one flexible tongue 20, 21 which extends in the longitudinal direction (L) of the channel 10, projecting outside thereof on at least one side 11, 12, and characterized in that said at least one flexible tongue 20, 21 is fixed on the bottom 15 of the channel.

The other characteristic features of the channel and the flexible tongue, such as for example the curvature at rest of the tongue, its concavity upwards with respect to the surface of the channel to which it is fixed (bottom), the coplanarity of the tongue with a surface of the channel to which it is fixed (bottom), in a working phase of maximum cushioning between the upright and the removable rib, etc., have already been described with reference to FIGS. 1-12 and consequently any repetition is avoided.

FIG. 15 is a cut-away view of the cushion 1 mounted on the edge of the removable rib 2000. In this drawing the tongue 20 has one end 22 on the bottom of the channel 10 and extends from the bottom with predefined curvature above the bottom. However, in a preferred embodiment, the end 22 is fixed on the bottom 15 of the channel 10 but the tongue extends outside of the channel, preferably with a curvature of the type shown in FIG. 6.

The method of performing cushioning between a profile and an upright provided by the present invention is described briefly below and can in any case be understood from the description, already given, of the structural aspects of the cushion and the profile, with the associated advantages.

The steps of the method comprise:
preparing a profile of a shade for a door or window;
mounting on a rib of the profile a plurality of cushions, each comprising a channel 10, mounted on (the rib of) the profile 100 and having a substantially C-shaped cross-section, and at least one flexible tongue 20, 21 on the channel 10, intended to provide a cushioning action between the profile 100 and a frame 1000 for assembly of the profile 100;
   this flexible tongue 20, 21 extending in the longitudinal direction L of the channel 10 and projecting outside thereof on at least one respective side 11, 12;
inserting the profile in the upright with the corresponding cushions directed towards the upright.

1. A cushion for a profile of a shade of a door or a window, the cushion comprising:
at least one flexible tongue that acts as a cushion between the profile and a frame for assembly of the profile;
wherein the at least one flexible tongue includes a base portion adapted to be directly faced towards the profile in use and at least an end portion adapted to be directly faced towards the frame.

2. The cushion according to claim 1, wherein no means is interposed between the at least one flexible tongue and the profile, in use.

3. The cushion according to claim 1, wherein the at least one flexible tongue has a U-shape, wherein the at least one flexible tongue includes two end portions adapted to be directly faced towards the frame, and wherein the base portion is at a middle of the two end portions.

4. The cushion according to claim 1, wherein the at least one flexible tongue has a rectangular cross section.

5. The cushion according to claim 1, wherein the at least one flexible tongue has a width from 0.3 cm to 2 cm.

6. The cushion according to claim 1, wherein the at least one flexible tongue has a length from 1.3 cm to 3 cm.

7. The cushion according to claim 1, wherein the end portion has a height that is from 0.8 cm to 3 cm, wherein the height is measured from the base portion on an axis perpendicular to the base portion.

8. The cushion according to claim 1, further comprising means for coupling the at least one flexible tongue to the profile.

9. The cushion according to claim 8, wherein the means for coupling include a pin adapted to be inserted into a locking hole in the profile.

10. The cushion according to claim 9, wherein the pin is on an outer surface of the base portion or on at least one end portion.

11. The cushion according to claim 8, wherein the means for coupling includes glue for gluing the base portion of the cushion to the profile.

12. The cushion according to claim 1, wherein the at least one flexible tongue has a predetermined curvature at rest.

13. The cushion according to claim 1, wherein the at least one flexible tongue is concave towards the up with respect to the profile.

14. The cushion according to claim 1, having a length substantially corresponding to a length of the profile.

15. A profile adapted to be associated to one or more cushions, wherein at least one of the one or more cushions includes at least one flexible tongue that acts as a cushion between the profile and a frame for assembly of the profile, the at least one flexible tongue including a base portion adapted to be directly faced towards the profile in use and at least an end portion adapted to be directly faced towards the frame, wherein the flexible tongue of the at least one of the one or more cushions is adapted to be arranged between the profile and the frame with no means interposed.

16. The profile according to claim 15, further comprising at least one locking hole adapted to lock a pin on the base portion of said cushion.

17. The profile according to claim 15, further comprising a plurality of locking holes at predetermined distances one from the other, adapted to lock pins on the base portion of a plurality of cushions.
